(19) United States
(12) Patent Application Publication
(10) Pub. No.: US 2025/0379260 A1
(43) Pub. Date: Dec. 11, 2025

(54) SOLID-STATE BATTERY CELLS WITH SEALING MEMBERS

(71) Applicant: FORD GLOBAL TECHNOLOGIES, LLC, Dearborn, MI (US)

(72) Inventors: Soo Yeon LIM, Canton, MI (US); Claudia JAZOWSKI, Ferndale, MI (US); Gang GUO, Saline, MI (US)

(21) Appl. No.: 18/738,599

(22) Filed: Jun. 10, 2024

(51) Int. Cl. H01M 10/0585; H01M 10/0525; H01M 50/184; H01M 50/186; H01M 50/193; B60L 50/64

(52) U.S. Cl. CPC H01M 10/0585; H01M 10/0525; H01M 50/184; H01M 50/186; H01M 50/193; B60L 50/64; H01M 2220/20

(57) ABSTRACT

A solid-state battery includes a solid-state electrolyte, a first electrode layer disposed against a first major side of the electrolyte, and a gasket disposed against a second major side of the electrolyte. The gasket defines an opening. A second electrode layer is disposed within the opening such that the gasket completely circumscribes the second electrode. The second electrode is disposed against the second major side of the electrolyte.

### TECHNICAL FIELD

This disclosure relates to vehicle traction batteries and more particularly to solid-state batteries with internal sealing members.

### BACKGROUND

Powertrain electrification is used by automakers to improve fuel economy. These systems can have higher electrical ratings and have high- and low-voltage components. The powertrain may include an electric machine powered by a traction battery assembly and/or an engine in the case of a hybrid. The battery may have lithium-ion chemistry. A battery includes a plurality of battery cells that may have a liquid electrolyte or a solid electrolyte.

### SUMMARY

According to an embodiment, a solid-state battery includes a solid-state electrolyte, a first electrode layer disposed against a first major side of the electrolyte, and a gasket disposed against a second major side of the electrolyte. The gasket defines an opening. A second electrode layer is disposed within the opening such that the gasket completely circumscribes the second electrode. The second electrode is disposed against the second major side of the electrolyte.

According to another embodiment, a method of forming a solid-state battery includes stacking a solid-state electrolyte on a first electrode layer; stacking a gasket with a central opening on the electrolyte such that a periphery of the gasket is aligned with a periphery of the electrolyte; inserting a second electrode layer into the central opening such that the second electrode is disposed on the electrolyte and fully surrounded by the gasket, wherein the gasket is thicker than the second electrode; stacking a body on the gasket to cover the gasket and second electrode; and compressing the gasket between the electrolyte and the body until the cathode contacts the body.

According to yet another embodiment, a solid-state battery includes a solid-state electrolyte having opposing first and second major sides. A first electrode layer is disposed against the first major side of the electrolyte and a gasket is disposed against the second major side of the electrolyte and defining an opening. A second electrode layer is disposed against the gasket and covering the second major side of the electrolyte, wherein an inner periphery of the opening is inboard of a periphery of the second electrode layer such that a face of the gasket is disposed on a major side of the second electrode layer.

### BRIEF DESCRIPTION OF THE DRAWINGS

FIG. 1 is a schematic diagram of an electric vehicle.

FIG. 2 is perspective view of a battery cell.

FIG. 3 is perspective view of another battery cell.

FIG. 4 is an exploded perspective view of the another battery cell.

FIG. 5 is an exploded perspective view of yet another battery cell.

FIG. 6 is a top of a battery cell.

FIG. 7 is a method of assembling a battery cell.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

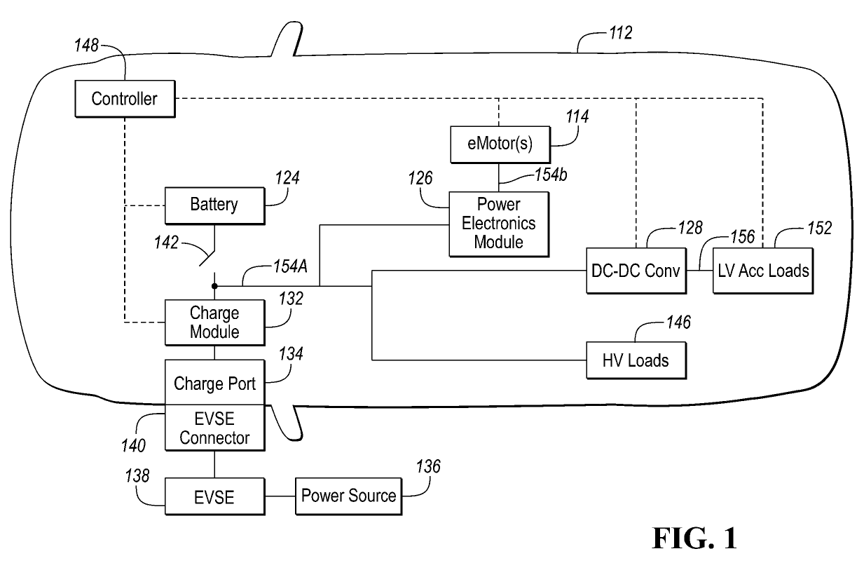

FIG. 1 depicts an electric vehicle 112. The vehicle 112 includes an electrified propulsion system having one or more electric machines 114 mechanically coupled to driven wheels. The electric machines 114 may be capable of operating as a motor or a generator. The electric machines 114 are arranged to provide propulsion torque as well braking. The electric machines 114 can operate as generators providing fuel economy benefits by recovering energy that would otherwise be lost as heat in a friction-braking system.

A traction battery assembly or battery pack 124 stores energy that can be used to power the electric machines 114. The battery pack 124 may provide a high-voltage direct current (DC) output. The battery 124 includes an electrical distribution system (EDS) 118 that carries power from the battery to loads and vice versa. Portions of the EDS 118 may be components of the battery 124 and other portions may be external to the battery 124. One or more contactors 142 may isolate the traction battery 124 from a DC high-voltage bus 154A when open and may couple the traction battery 124 to the DC high-voltage bus 154A when closed. The traction battery 124 is electrically coupled to one or more power electronics modules 126 via the DC high-voltage bus 154A. The power electronics module 126 is also electrically coupled to the electric machines 114 and provides the ability to bi-directionally transfer energy between AC high-voltage bus 154B and the electric machines 114. According to some examples, the traction battery 124 may provide a DC current while the electric machines 114 operate using a three-phase alternating current (AC). The power electronics module 126 may convert the DC current to a three-phase AC current to operate the electric machines 114. In a regenerative mode, the power electronics module 126 may convert the three-phase AC current output from the electric machines 114 acting as generators to DC current compatible with the traction battery 124.

In addition to providing energy for propulsion, the traction battery 124 may provide energy for other vehicle electrical systems. The vehicle 112 may include a DC/DC converter module 128 that is electrically coupled to the high-voltage bus 147. The DC/DC converter module 128 may be electrically coupled to a low-voltage bus 149. The DC/DC converter module 128 may convert the high-voltage DC output of the traction battery 124 to a low-voltage DC supply that is compatible with low-voltage vehicle loads 145. The low-voltage bus 149 may be electrically coupled to an auxiliary battery 130 (e.g., 12V battery). The low-voltage loads 145 may be electrically coupled to the low-voltage bus 149. The low-voltage loads 145 may include various controllers within the vehicle 112.

The traction battery 124 of vehicle 112 may be recharged by an off-board power source 136. The off-board power source 136 may be a connection to an electrical outlet. The external power source 136 may be electrically coupled to a charger or another type of electric vehicle supply equipment (EVSE) 138. The off-board power source 136 may be an electrical power distribution network or grid as provided by an electric utility company. The EVSE 138 provides circuitry and controls to regulate and manage the transfer of energy between the power source 136 and the vehicle 112. The off-board power source 136 may provide DC or AC electric power to the EVSE 138. The EVSE 138 includes a charge connector 140 for plugging into a charge port 134 of the vehicle 112. The charge port 134 may be any type of port configured to transfer power from the EVSE 138 to the vehicle 112. The charge port 134 may be electrically coupled to a charge module or on-board power conversion module 132. The power conversion module 132 conditions power supplied from the EVSE 138 to provide the proper voltage and current levels to the traction battery 124. The power conversion module 132 interfaces with the EVSE 138 to coordinate the delivery of power to the vehicle 112. The EVSE connector 140 may have pins that mate with corresponding recesses of the charge port 134. Alternatively, various components described as being electrically coupled or connected may transfer power using wireless inductive coupling or other non-contact power transfer mechanisms. The charge components including the charge port 134, power conversion module 132, power electronics module 126, and DC-DC converter module 128 may collectively be considered part of a power interface system configured to receive power from the off-board power source 136.

When the vehicle 112 is plugged in to the EVSE 138, the contactors 142 may be in a closed state so that the traction battery 124 is coupled to the high-voltage bus 147 and to the power source 136 to charge the battery. The vehicle may be in the ignition-off condition when plugged in to the EVSE 138.

One or more wheel brakes (not shown) may be provided as part of a braking system to slow the vehicle 112 and prevent rotation of the vehicle wheels. The brakes may be hydraulically actuated, electrically actuated, or some combination thereof. The brake system may also include other components to operate the wheel brakes. The brake system may include a controller to monitor and coordinate operation. The controller monitors the brake system components and controls the wheel brakes 144 for vehicle deceleration. The brake system also responds to driver commands via a brake pedal input and may also operate to automatically implement features such as stability control. The controller of the brake system may implement a method of applying a requested brake force when requested by another controller or sub-function.

One or more high-voltage electrical loads 146 may be coupled to the high-voltage bus 147. The high-voltage electrical loads 146 may have an associated controller that operates and controls the high-voltage electrical loads 146 when appropriate. The high-voltage loads 146 may include components such as compressors and electric heaters.

The various components discussed may have one or more associated controllers to control, monitor, and coordinate the operation of the components. The controllers may communicate via a serial bus (e.g., Controller Area Network (CAN)) or via discrete conductors. In addition, a vehicle system controller 148 may be provided to coordinate the operation of the various components.

While illustrated as one controller, the controller may be part of a larger control system and may be controlled by various other controllers throughout the vehicle 112, such as a vehicle system controller (VSC). It should therefore be understood that the controller and one or more other controllers can collectively be referred to as a “controller” that controls various actuators in response to signals from various sensors to control functions. The controller may include a microprocessor or central processing unit (CPU) in communication with various types of computer-readable storage devices or media. Computer-readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle. The controller communicates with various vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU.

In one embodiment, a system controller 148, although represented as a single controller, may be implemented as one or more controllers, may monitor operating conditions of the various vehicle components. According to the example of FIG. 1, at least the electric machines 114, the EDS 118, the traction battery 124, the DC-DC converter 128, the charging module 132, the high-voltage loads 146, and low-voltage loads 152 are in communication with the controller 148. The traction battery 124 also includes a current sensor to sense current that flows through the traction battery 124. The traction battery 124 also includes a voltage sensor to sense a voltage across terminals of the traction battery 124. The voltage sensor outputs a signal indicative of the voltage across the terminals of the traction battery 124. The traction battery current sensor outputs a signal indicative of a magnitude and direction of current flowing into or out of the traction battery 124.

The charging module 132 also includes a current sensor to sense current that flows from the EVSE 138 to the traction battery 124. The current sensor of the charging module 132 outputs a signal indicative of a magnitude and direction of current flowing from the EVSE 138 to the traction battery 124.

The current sensor and voltage sensor outputs of the traction battery 124 are provided to the controller 148. The controller 148 may be programmed to compute a state of charge (SOC) based on the signals from the current sensor and the voltage sensor of the traction battery 124. Various techniques may be utilized to compute the state of charge. For example, an ampere-hour integration may be implemented in which the current through the traction battery 124 is integrated over time. The SOC may also be estimated based on the output of the traction battery voltage sensor 104. The specific technique utilized may depend upon the chemical composition and characteristics of the particular battery.

The controller 148 may also be configured to monitor the status of the traction battery 124. The controller 148 includes at least one processor that controls at least some portion of the operation of the controller 148. The processor allows onboard processing of commands and executes any number of predetermined routines. The processor may be coupled to non-persistent storage and persistent storage. In an illustrative configuration, the non-persistent storage is random access memory (RAM) and the persistent storage is flash memory. In general, persistent (non-transitory) storage can include all forms of storage that maintain data when a computer or other device is powered down.

A desired SOC operating range may be defined for the traction battery 124. The operating ranges may define an upper and lower limit at which the SOC of the battery 124 is bounded. During vehicle operation, the controller 148 may be configured to maintain the SOC of the battery 124 within the desired operating range. In other cases, the battery is recharged when at rest and connected to an off-board power source. Based on a rate of battery depletion and/or recharge, charging of the traction battery may be scheduled in advance based on approaching an SOC low threshold. The timing and rate of recharging may also be opportunistically selected to maintain voltage and SOC within predetermined ranges.

While not shown, the vehicle 112 includes an accelerator pedal that enables the driver to request torque. The vehicle may be programmed to determine a driver-demanded torque based on a position of the accelerator pedal and vehicle speed. The driver-demanded torque may be a raw wheel torque that is commanded by the driver and is used to control the torque produced by the motors 114.

The above-described vehicle example is but one application for the below described battery. It is to be understood that the battery 124 may be used in any suitable application including vehicles as described above.

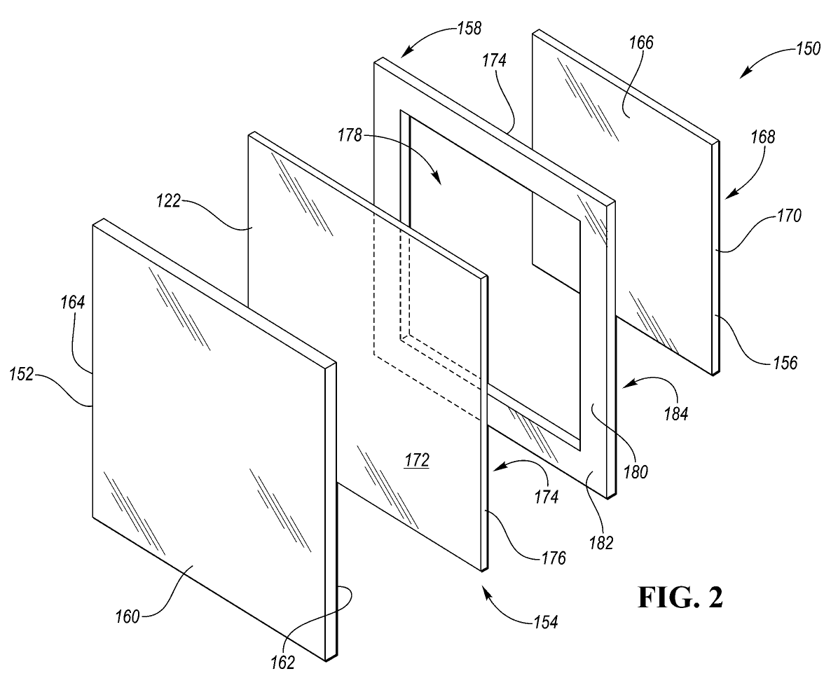

Referring to FIG. 2, the battery pack 124 includes one or more battery arrays that include a stack of battery cells 150. The cells 150 may be lithium-ion (Li-ion) chemistry with a solid-state electrolyte (sometimes referred to as a “solid-state battery”).

The cell 150 includes an anode layer 152, a solid-state electrolyte 154, a cathode layer 156, and a gasket 158. These components are arranged in a stack to form the cell 150. The anode layer 152 may be a thin rectangular sheet having major sides 160, 162 and edges 164 extending between the major sides. Similarly, the cathode 156 may be a thin rectangular sheet having major sides 166, 168 and edges 170 extending between the major sides. The layers 152, 156 may include a foil with a coating on one or both sides (not shown). The electrolyte 154 also has major sides 172 and 174 and edges 176 extending therebetween.

The anode 160 and the electrolyte 154 have the same cross-sectional size and shape in the illustrated embodiment but may be different sizes in others. That is, when the major side 162 of the anode is disposed against the major side 172 of the electrolyte, the edges 162 of the anode and the edges 176 of the electrolyte are aligned with each other. As will be described in more detail below, the cathode has a cross-sectional shape and size that is smaller than the anode and the electrolyte.

The gasket 158 has a central opening 178. The gasket 158 may be rectangular having a border 180 that defines the central opening 178. The gasket has opposing sealing faces 182, 184 that engage with adjacent components within the stack of the cell 150. In the illustrated embodiment, the gasket 158 is rectangular having the same cross-sectional size and shape as the anode 152 and the electrolyte 154. In some embodiments, the gasket 158 may be slightly larger than the anode 152 and the electrolyte 154. The central opening 178 may also be rectangular and may be sized and shaped to match the size and shape of the cathode 156.

The cathode 156 is sized to be received within the central opening 178 of the gasket 158. That is, when the cell 150 is fully assembled, the cathode 156 sits within the central opening 178 with the major side 166 disposed against the major side 174 of the electrolyte 154 and with the border 180 of the gasket 158 completely surrounding the edges 170 of the cathode. In some embodiments, the cross-sectional shape and size of the cathode 156 substantially matches the cross-sectional shape and size of the central opening 178 such that the edges 170 of the cathode are disposed against the periphery of the central opening 178. In this context, “substantially matches” means within two percent. In some embodiments, the cross-sectional shape and size of the cathode 156 is slightly larger than the cross-sectional shape and size of the central opening 178 such that the edges 170 of the cathode are slightly overlapped against the periphery of the central opening 178.

The gasket 158 may be formed of a compressible material. Here, the thickness of the gasket may be thicker than the thickness of the cathode 156 when in the resting state. During assembly, the cell 150 gets compressed during the stacking process and thus the gasket 108 becomes compressed to substantially match the thickness of the cathode 156.

The gasket 158 may be formed from an elastic and flexible polymer material. For example, the gasket 158 may be formed from one of polyamide film, kapton film, or mylar. The gasket may be an insulating material and electrically, chemically, and thermally stable at operating temperatures of the cell 150. In some embodiments, the gasket material may have inherent thermal properties allowing the gasket 158 to act as a heat sink. The gasket material may be sticky or have a high coefficient of friction to prevent gasket movement during the assembly process. In some embodiments, the gasket material may be configured to be adhere to the other cell components before or after compression or heating.

The gasket 158 may be a fully formed, standalone component assembled with the other cell components during assembly of the cell 150. Alternatively, the gasket 158 may be a liquid that is applied during the assembly process and then later hardens to form the gasket 158.

FIG. 2 is merely one example embodiment and others are contemplated. For example, in other embodiments the anode and the cathode are switched. In some embodiments, the gasket may have a resting position where the outer boundary of the gasket is smaller than the cross-sectional area of the anode. In this embodiment, the gasket may expand under compression to conform with the size of the anode.

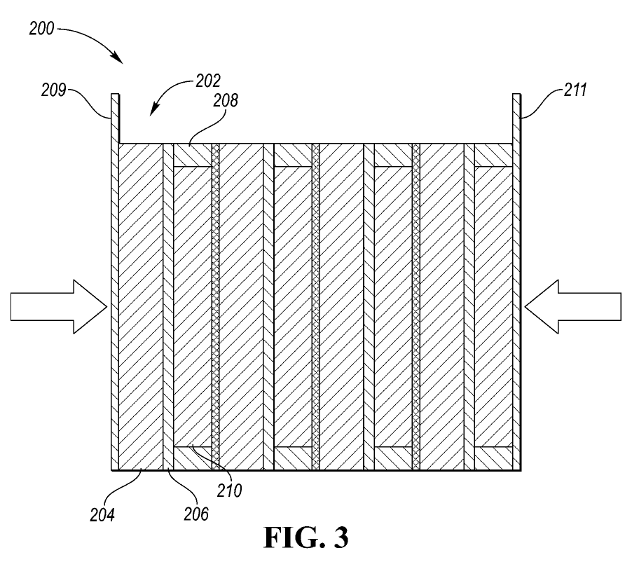

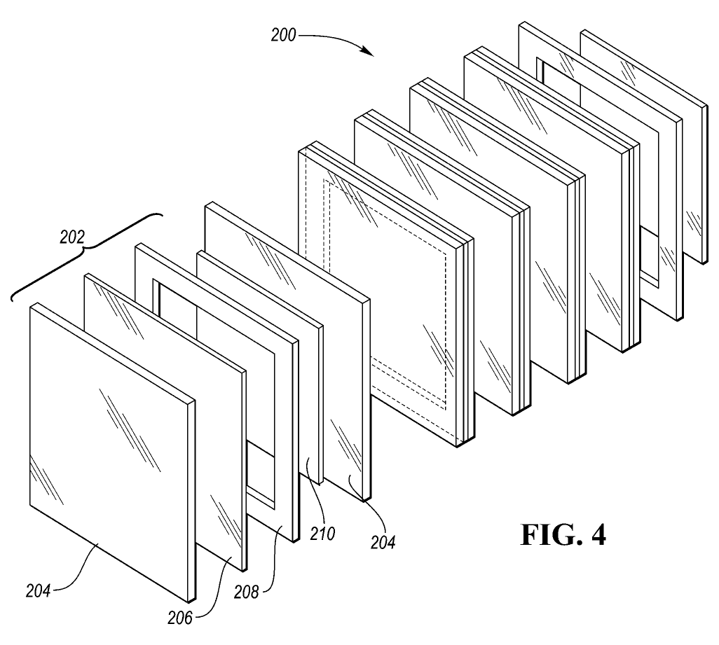

The cells may be monopolar or bipolar including one or more units of an anode, an electrolyte, a gasket, and a cathode. In a monopolar configuration, the anode and cathode units may be double sided coatings on a foil. In a bipolar configuration, the anode and cathode may be on opposing sides of the same foil. FIGS. 3 and 4 illustrate an example bipolar embodiment. The cell 200 includes a repeating pattern of anode/cathode units 202 arranged in a linear stack. Each unit 202 includes an anode 204, solid-state electrolyte 206, a gasket 208, and a cathode 210. Each unit 202 may have a same or similar structure to the above-described cell 150 and for brevity will not be described again. In the bipolar assembly, the major side of the cathode 210 that is opposite the side disposed against the electrolyte 206 is attached to the anode 204 of the next unit 202 (with a foil between them). This pattern repeats for a desired number of units. In the illustrated embodiment, six units 202 are shown, however, this is just one example and the number of units may be increased or decreased as desired.

The cell 200 includes terminal plates, such as a positive terminal plate 209 connected to the first anode and a negative terminal plate 211 connected to the last cathode. A housing or other outer member is provided around all the units 200 to provide protection from the elements and to generally seal the cell 200. Terminal tabs of the terminal plates may extend out through the housing allowing an electrical connection with other cells.

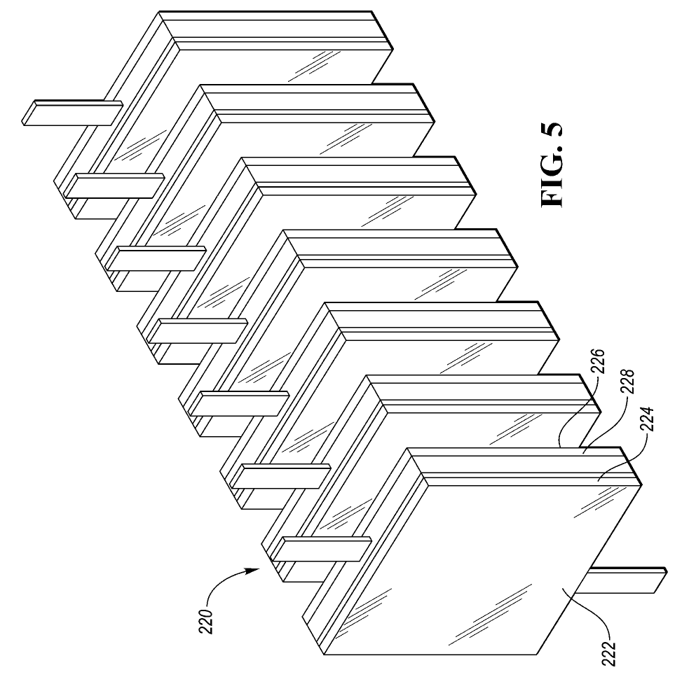

FIG. 5 illustrates a monopolar embodiment in which each unit is a standalone single cell 220. The cells 220 may be as described above with reference to cell 150 with the inclusion of a positive terminal plate 222 connected to the anode 224 and a negative terminal plate 226 connected to the cathode 228.

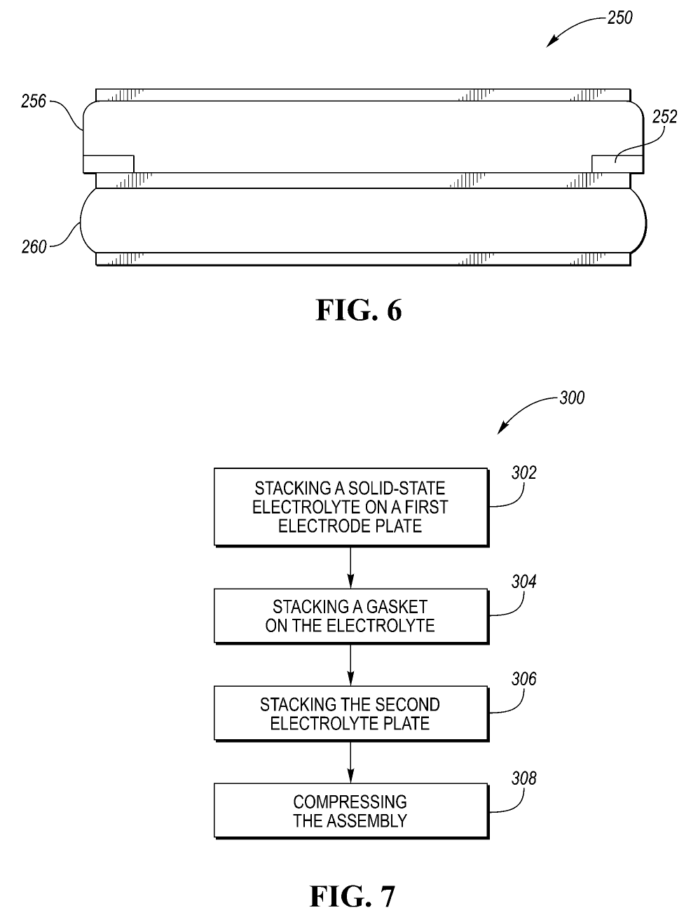

FIG. 6 illustrates another battery cell 250 with a different type of gasket. In this embodiment, the gasket 252 is thinner than the above-described gaskets and is designed to be disposed between a major side 254 of the cathode 256 and the solid-state electrolyte 258. The gasket 252 still includes a central opening allowing the major sides of the cathode 256 to contact the electrolyte 258. However, unlike the above-described embodiments, the central opening is not sized to completely receive the cathode 256 therein. Instead, the gasket 252 becomes compressed between the cathode and the electrolyte. In this embodiment, the cathode 256 may have the same cross-sectional size and shape as the anode 260, or may be smaller than the anode. In this embodiment, the gasket 252 may be a stand-alone solid component that is fully formed prior to assembling the stack, or may be a liquid gasket during application and later hardens under the heat and/or compression of the cell assembly process. While the gasket 252 is illustrated as being located between the electrolyte and the cathode, the gasket can alternatively be provided between the anode and the electrolyte. The gasket 252 may be utilized in both monopolar cells and bipolar cells as discussed above.

The above-described battery cells may be assembled by stacking the various layers and then compressing them to ensure a satisfactory interface between the solid-state electrolyte and the electrodes, e.g., the anode and the cathode. It is important to apply uniform compression around the periphery of the anode and cathode to prevent damage to the solid-state electrolyte. The difference in sizing between the anode and the cathode can create stress points along the periphery of the solid-state electrolyte. The above-described gaskets, which are located at this periphery helps to distribute compression more evenly. For example, when the cathode is smaller than the anode, the gasket fills in the overhang area of the electrolyte layer to ensure that the periphery of the electrolyte layer does not experience any bending stresses at the edges of the smaller cathode. The gasket also provides an additional dielectric layer between the anode and cathode.

The above-described cells may be assembled using a method 300, shown in FIG. 7. The method 300 includes stacking a solid-state electrolyte on a first electrode layer (e.g., an anode) at operation 302. At operation 304, a gasket with a central opening is installed on the electrolyte. In some embodiments, the gasket is installed such that a periphery of the gasket is aligned with a periphery of the electrolyte and then a second electrode layer is placed into the central opening such that the second electrode is disposed on the electrolyte and fully surrounded by the gasket at operation 306. In other embodiments, the gasket is placed between the major sides of the electrolyte and the electrode layer. In some environments, this process may be repeated multiple times creating a plurality of units within a single cell. Depending on if the cell is monopolar or bipolar, a body is then disposed on the gasket and/or second electrode to cover the gasket and second electrode. The body may be a terminal or another electrode. Once the stack is complete, the stack is compressed at operation 308. In embodiments where the gasket is thicker than the second electrode, the gasket is sufficiently compressed between the electrolyte and a body until the cathode contacts the body and the electrolyte.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A solid-state battery comprising:
a solid-state electrolyte;
a first electrode layer disposed against a first major side of the electrolyte;
a gasket disposed against a second major side of the electrolyte, the gasket defining an opening;
a second electrode layer disposed within the opening such that the gasket completely circumscribes the second electrode, wherein the second electrode is disposed against the second major side of the electrolyte.

2. The solid-state battery of claim 1, wherein the first electrode is an anode and the second electrode is a cathode.

3. The solid-state battery of claim 1 further comprising a third electrode layer having a first portion disposed against the second electrode and a second portion disposed against the gasket.

4. The solid-state battery of claim 3, wherein the first electrode is an anode, the second electrode is a cathode, and the third electrode is an anode.

5. The solid-state battery of claim 1, wherein a periphery of the second electrode layer is disposed against a periphery of the opening.

6. The solid-state battery of claim 1, wherein a cross-sectional area of the opening substantially matches a cross-sectional area of the second electrode.

7. The solid-state battery of claim 1, wherein an uncompressed thickness of the gasket is greater than a thickness of the second electrode layer.

8. The solid-state battery of claim 1, wherein the gasket is formed of polyamide film, kapton film, or mylar.

9. The solid-state battery of claim 1, wherein the electrolyte, the first electrode, the second electrode, and the gasket are rectangular.

10. The solid-state battery of claim 9, wherein the first electrode and the electrolyte have a same cross-sectional size, and a cross-sectional size of the second electrode is smaller than the cross-sectional size of the first electrode and the electrolyte.

11. The solid-state battery of claim 10, wherein the gasket has a same cross-sectional size as the first electrode and the electrolyte.

12. The solid-state battery of claim 11, wherein the first electrode is an anode and the second electrode is a cathode.

13. The solid-state battery of claim 12 further comprising a second anode layer having a first portion disposed against the cathode and a second portion disposed against the gasket.

14. A method of forming a solid-state battery comprising:
stacking a solid-state electrolyte on a first electrode layer;
stacking a gasket with a central opening on the electrolyte such that a periphery of the gasket is aligned with a periphery of the electrolyte;
inserting a second electrode layer into the central opening such that the second electrode is disposed on the electrolyte and fully surrounded by the gasket, wherein the gasket is thicker than the second electrode;
stacking a body on the gasket to cover the gasket and second electrode; and
compressing the gasket between the electrolyte and the body until the cathode contacts the body.

15. The method of claim 14, wherein the body is a third electrode layer.

16. The method of claim 15, wherein the third electrode has a same polarity as the first electrode.

17. The method of claim 14, wherein the first electrode is an anode and the second electrode is a cathode.

18. The method of claim 14, wherein the electrolyte, the first electrode, the second electrode, and the gasket are rectangular.

19. The method of claim 18, wherein the first electrode and the gasket have a same cross-sectional size and shape, wherein the opening is rectangular, and the second electrode and the opening have a substantially same size and shape such that the second electrode fits within the opening with a periphery of the second electrode disposed against a periphery of the opening.

20. A solid-state battery comprising:
a solid-state electrolyte having opposing first and second major sides;
a first electrode layer disposed against the first major side of the electrolyte;
a gasket disposed against the second major side of the electrolyte and defining an opening;
a second electrode layer disposed against the gasket and covering the second major side of the electrolyte, wherein an inner periphery of the opening is inboard of a periphery of the second electrode layer such that a face of the gasket is disposed on a major side of the second electrode layer.
